(19) United States
(12) Patent Application Publication
(10) Pub. No.: US 2011/0268199 A1
(43) Pub. Date: Nov. 3, 2011

(54) Embedded Communications Capabilities for Radio-Controlled Improvised Explosive Device Force Protection Systems

(75) Inventors: Sean Thomas O'Hara, North Syracuse, NY (US); Ryan Gary Aures, Camillus, NY (US)

(73) Assignee: SRC, INC., North Syracuse, NY (US)

(21) Appl. No.: 12/769,210

(22) Filed: Apr. 28, 2010

(51) Int. Cl. H04L 27/00

(52) U.S. Cl. 375/259

(57) ABSTRACT

A method and system for embedded communications that allows for FFT/IFFT-capable radio-controlled improvised explosive devices (“RC-IED”) force protection systems to communication information across local networks to enhance force protection operations and to provide additional data capacity to support other tactical operations. The communications system utilizes a significant amount of existing system hardware and software such that the addition of these communications capabilities does not significantly affect the unit cost of the RC-IED force protection system within which it is embedded.

### BACKGROUND OF THE INVENTION

1. Field of the Invention

The present invention relates to a multi-tone transceiver system for communications, and, more specifically, to a multi-tone transceiver system utilizing pre-existing radio-controlled improvised explosive device force protection systems to embed communications.

2. Description of the Related Art

Force protection systems, which are defined as any technology or device used to protect the welfare of forces in a theater, are an essential element of military preparedness. For example, force protection technologies that allow for the early detection and defeat of radio-controlled improvised explosive devices (“RC-IED”) prevent the serious injuries, damage to property, and loss of life associated with these RC-IED threats. Since force protection systems are so vital, they are the subject of much research and development.

Several RC-IED force protection systems utilize frequency division multiplexing (“FDM”), a process that allows simultaneous transmission of multiple signals, each with a unique frequency, across a single transmission path. Orthogonal frequency division multiplexing (“OFDM”), in contrast, transmits multiple signals with frequencies spaced to make them orthogonal to prevent interference. OFDM is typically used to transmit digital data over a radio wave and forms the basis, for example, of modern wi-fi technology.

In the field, these force protection systems often suffer from a need to handle ever-increasing amounts of data as the systems are forced to communicate or engage new technologies which possess more advanced technology to utilize or analyze data. There is also a continued need to transmit or receive an ever-increasing amount of data through local networks to enhance force protection operations or provide additional data capacity to support other tactical operations.

### BRIEF SUMMARY OF THE INVENTION

It is therefore a principal object and advantage of the present invention to provide a method and system for embedded communications.

It is another object and advantage of the present invention to provide a method and system for embedding communications in counter-RC-IED force protection technologies.

It is yet another object and advantage of the present invention to provide a method and system for embedding communications to allow for increased communication capabilities across local networks in the field to enhance RC-IED force protection operations.

It is another object and advantage of the present invention to provide a method and system for embedding communications to allow for increased communication capabilities across local networks in the field to provide additional data capacity to support other tactical operations.

Other objects and advantages of the present invention will in part be obvious, and in part appear hereinafter.

In accordance with the foregoing objects and advantages, the present invention provides a method and system for embedded communications that allows FFT/IFFT-capable RC-IED force protection systems to communication information across local networks to enhance force protection operations and to provide additional data capacity to support other tactical operations. The communications system utilizes a significant amount of existing system hardware and software such that the addition of these communications capabilities does not significantly affect the unit cost of the RC-IED force protection system within which it is embedded.

A second aspect of the present invention provides a method for communicating a data message. As an initial step, a multitone signal is generated and transmitted. To accomplish this, a data message is encrypted and scheduled for transmission, a multitone signal is generated, and it is then transmitted from a first counter-improvised explosive device. As a second step, the multitone signal is received by a second counter-improvised explosive device. The step of receiving the multitone signal includes the steps of receiving said transmitted multitone signal by the second counter-improvised explosive device, converting the signal into a digital data message, and decrypting the digital data message.

A third aspect of the present invention provides a method for communicating a data message that further includes the steps of forward error correcting the encrypted data message and decoding the forward error corrected data message after it is received.

A fourth aspect of the present invention provides a method for communicating a data message wherein the step of generating the multitone signal further includes the steps of transforming the signal by inverse fast Fourier transform, converting the transformed signal from digital to analog, and up-converting the multitone signal to its center frequency.

A fifth aspect of the present invention provides a system for communicating a data message. The system includes a first counter-improvised explosive device which is adapted to transmit an encrypted data message to a second counter-improvised explosive device. The first counter-improvised explosive device includes: (i) a first user interface which has been modified to control at least a portion of the data message communication system; (ii) a first synchronization source; (iii) a digital to analog converter; and (iv) a first antenna. The system also includes a second counter-improvised explosive device which is adapted to receive the encrypted data message from the first counter-improvised explosive device. The second counter-improvised explosive device includes: (i) a second user interface which has been modified to control at least a portion of the data message communication system; (ii) a second synchronization source; (iii) an analog to digital converter; and (iv) a second antenna.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic representation of an embodiment of the method according to the present invention.

FIG. 2 is a schematic representation of an embedded communications system.

### DETAILED DESCRIPTION OF THE INVENTION

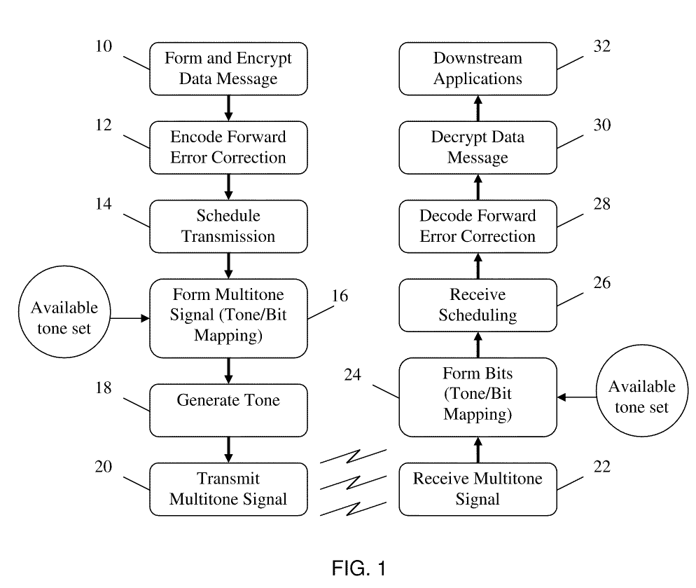

Referring now to the drawings, wherein like reference numerals refer to like parts throughout, there is seen in FIG. 1 a schematic representation of the embedded communications method. As an initial step 10, a data message is created and encrypted. The encryption can be any form of encryption known to those skilled in the art to prevent detection of the message or deter decryption if it is detected.

In step 12, the encrypted data message undergoes forward error correction (“FEC”). The method of forward error correction is any method known in the art in which redundant data is added to a message to preserve or otherwise enhance a transmitted message. After FEC, the message is scheduled by the system for transmission, as shown in step 14.

In step 16, a multitone signal is formed within each band utilized for communications by combining the available tone set, tone/bit mapping, and the information bits. Here, active tones are defined as those frequencies that are selected to carry the bit information within the multitone signal. These active tones are selected though a Transport Security (TRANSEC) methodology that maintains synchronization with other embedded communications systems using a combination of GPS timing and pilot channel information transmission. The active tones will change every time the TRANSEC validity interval changes, so that the communications can be protected from jamming and intercept. The available tone set represents the FFT bin locations across the entire operating bandwidth of the system that are available for utilization based upon environmental noise, interference, etc. The available tone set can be static for a given theater of operation, or dynamic, based upon environmental sensing provided through the RC-IED Force Protection systems capabilities. The multi-tone signals are generated in step 18 and transmitted in step 20 using any method of tone generation and transmission known to those skilled in the art. In a preferred embodiment of the present invention, the multi-tone signals are generated by applying an IFFT followed by digital to analog conversion, and up converting the baseband multitone signals to their respective center frequencies. In the preferred embodiment, the tone is generated and transmitted using components that are already part of the RC-IED force protection system. In yet another embodiment, the RC-IED force protection system is constructed or retro-fitted with components for tone generation and/or transmission.

In step 22, the transmission is received by another RC-IED force protection system and is converted to a digital data message via tone/bit mapping, shown in step 24. In step 26, the scheduling is received and implemented by the receiving RC-IED force protection system. In step 28, the FEC is decoded, and in step 30 the message is decrypted. The decrypted message or data can then be utilized by any downstream application, as shown in step 32.

The embedded communications system utilizes a significant amount of existing system hardware and software such that the addition of these communications capabilities does not significantly affect the unit cost of the RC-IED force protection system within which it is embedded.

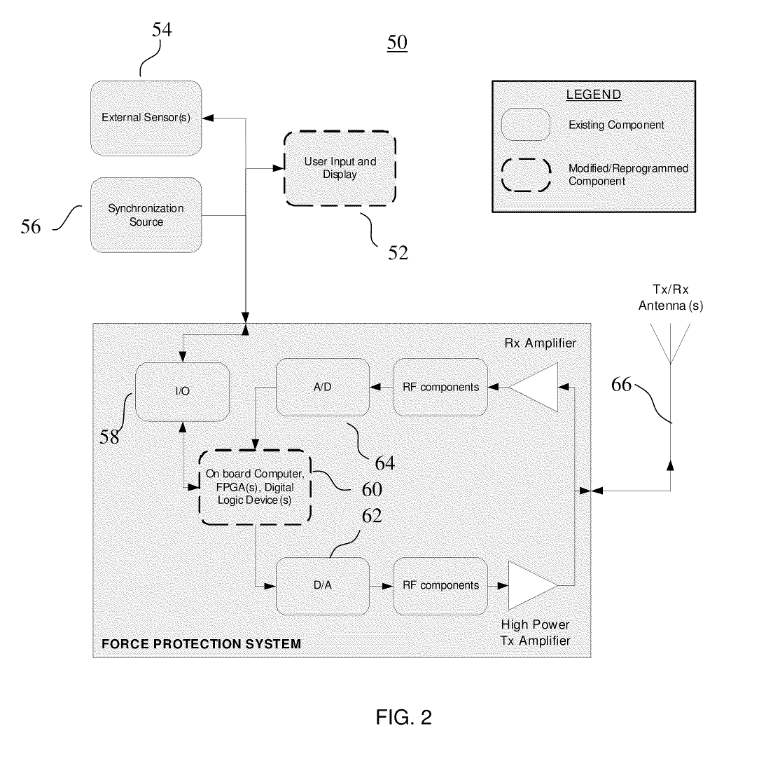

FIG. 2 depicts an example of an RC-IED force protection system 50 as it is used for an embedded communications system. All components shown in FIG. 2 are existing components of a typical RC-IED force protection system. Some of these components will be modified for a embedded communications system, and others will not.

An RC-IED force protection system typically includes a user input or interface and display 52. The input and display software will be modified to allow interaction with, and control of, the embedded communications system. Display 52 will also be modified to show transmitted and received data from the communications system.

An RC-IED force protection system may have one or more external sensors 54, which may or may not be used as data sources for an embedded communications system.

An RC-IED force protection system includes a synchronization source 56 that is utilized by the embedded communications protocol to synchronize both transmit and receive windows, as well as to synchronize COMSEC and TRANSEC parameters. In a preferred embodiment, the synchronization source is GPS.

An RC-IED force protection system also contains some method for I/O, which is unmodified by an embedded communications system.

An RC-IED force protection system may or may not include an on board computer 60. Computer 60 is physically unmodified by an embedded communications system. It may be used for some portion of steps 10, 12, 14, and 16 from FIG. 1 on transmit, as well as steps 24, 26, 28, 30, and 32 from FIG. 1 on receive. Computer 60 implements these processes via a software update. Any of these processes can utilize either the computer or the digital logic portion of the force protection system. An RC-IED force protection system also typically uses an FPGA or some other digital logic device. The VHDL or other such programming will be modified for an embedded communications system. It may be used to implement or schedule all or some portion of the processes shown in FIG. 1 for embedded communications.

An RC-IED force protection system includes digital to analog 62 (“D/A”) and analog to digital 64 (“A/D”) converters. These devices will be used by the embedded communications system to convert between the digital and analog domains. The D/A and A/D converters may be part of the digital logic device, or may be a separate component.

An RC-IED force protection system includes RF components such as mixers, combiners, cables, and amplifiers. These components have the capability to transmit and receive a multitone signal like that described by the embedded communications system. The RF hardware is unmodified by the embedded communications system.

An RC-IED force protection system includes either separate or combined receive and transmit antennas 66, which are capable or transmitting and receiving high power signals. The antenna(e) will be unmodified by the force protection system.

In one embodiment of the present invention, the embedded communication system is part of any fast Fourier transform (“FFT”)/inverse fast Fourier transform (“IFFT”)-capable force protection system. Since the embedded waveform utilizes components of the FFT/IFFT-based RC-IED force protection system that are deconflicted from the force protection timelines, the embedded communications capabilities do not affect the normal force protection operations. Deconflicting is achieved using any process or method of query resolution known to those skilled in the art—where time and frequency domain communications are selected such that they may be used without any significant degradation of the RC-IED force protection system's performance. Deconfliction details are sensitive and extremely dependent upon the operational timeline of the RC-IED force protection systems as well government-defined timing protocols and policies.

Among other RC-IED force protection techniques, the embedded communication system can utilize transport security and communications security techniques to ensure that the message information is both properly encrypted and is protected from undesired intercept. This is accomplished by using friendly encryption keys and GPS to synchronize a rolling CRYPTO vector for all units participating in the local network This CRYPTO vector is used by all units within the network to maintain both COMSEC and TRANSEC synchronization. The CRYPTO vector is active for a set CRYPTO validity interval before it changes or “rolls” to its next state.

The waveform is designed to be robust to noise and interference. In a preferred embodiment of the present invention, the system utilizes frequency set hopping to transmit the signals among many different frequency channels using a switching sequence known to the transmitter and the receiver. In yet another embodiment, the system utilizes environmental frequency mapping in its detection circuitry to recover information in the presence of interference and transmit intermodulation effects.

Although the present invention has been described in connection with a preferred embodiment, it should be understood that modifications, alterations, and additions can be made to the invention without departing from the scope of the invention as defined by the claims.

What is claimed is:

1. A method for communicating a data message, said method comprising the steps of:
transmitting a multitone signal, wherein the step of transmitting a signal comprises the steps of encrypting said data message, scheduling the data message for transmission, generating the multitone signal, and transmitting the generated multitone signal from a first counter-improvised explosive device; and
receiving the multitone signal, wherein the step of receiving the multitone signal comprises the steps of receiving said transmitted multitone signal by a second counter-improvised explosive device, converting said signal into a digital data message, and decrypting the digital data message.

2. The method of claim 1, further comprising the steps:
forward error correcting said encrypted data message after encrypting; and
decoding the forward error corrected data message after it is received.

3. The method of claim 1, wherein the first and second counter-improvised explosive devices are radio-controlled counter-improvised explosive devices.

4. The method of claim 1, wherein the multitone signal is formed from an available tone set.

5. The method of claim 1, wherein the step of generating the multitone signal further comprises the steps of:
transforming the signal by inverse fast Fourier transform; and
converting the transformed signal from digital to analog.

6. The method of claim 5, further comprising the step of:
up-converting the multitone signal to its center frequency.

7. The method of claim 1, wherein at least one component of said first counter-improvised explosive device is modified before a mulitone signal is generated.

8. The method of claim 1, wherein the decrypted digital data message is used by a downstream application.

9. The method of claim 1, wherein the decrypted digital data message is communicated to a user.

10. A system for communicating a data message, the system comprising:
a first counter-improvised explosive device, wherein said first counter-improvised explosive device is adapted to transmit an encrypted data message to a second counter-improvised explosive device, the first counter-improvised explosive device comprising:
a first user interface, wherein said first user interface is modified to control at least a portion of the data message communication system;
a first synchronization source;
a digital to analog converter; and
a first antenna; and
a second counter-improvised explosive device, wherein said second counter-improvised explosive device is adapted to receive an encrypted data message from a first counter-improvised explosive device, the second counter-improvised explosive device comprising:
a second user interface wherein said second user interface is modified to control at least a portion of the data message communication system;
a second synchronization source;
an analog to digital converter; and
a second antenna.

11. The system of claim 10, wherein said first and second synchronization sources comprise a GPS system.

12. The system of claim 10, wherein the first and second counter-improvised explosive devices are radio-controlled counter-improvised explosive devices.

13. The system of claim 10, wherein said first user interface further comprises modified software.

14. The system of claim 13, wherein said second user interface further comprises modified software.

15. The system of claim 10, wherein said first counter-improvised explosive device further comprises a first computer, said first computer comprising software modified for said system.

16. The system of claim 15, wherein said second counter-improvised explosive device further comprises a second computer, said second computer comprising software modified for said system.
